(19) United States
(12) Patent Application Publication
(10) Pub. No.: US 2018/0117520 A1
(43) Pub. Date: May 3, 2018

(54) POLLUTION CONTROL DEVICE

(71) Applicant: DAVID M. GONZALEZ, CORONA, CA (US)

(72) Inventor: DAVID M. GONZALEZ, CORONA, CA (US)

(21) Appl. No.: 15/339,799

(22) Filed: Oct. 31, 2016

(51) Int. Cl. B01D 47/06; C02F 1/00

(52) U.S. Cl. CPC B01D 47/06; C02F 2103/18; C02F 1/001

(57) ABSTRACT

The present invention discloses a pollution carrying waste treatment apparatus. The disclosed apparatus consists of a pollution carrying tube connected to the treatment cylinder through an elbow for forcing the pollution into the treatment cylinder for treating it with mist sprayer and allowing the treated water to run through water filters to separate contaminated water and re-use the pure water for further processing.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

### (1) Field of the Invention

This invention relates generally to the field of environmental pollution control and more particularly to a system and method for effectively eliminating impurities from an exhaust air stream prior to the air being released into the atmosphere.

### (2) Background of the Invention

Numerous industries produce exhaust air containing harmful particulates to the atmosphere and living beings. Such industries include, but are not limited to, automotive, wood products, laundry dryers, furniture manufacturers, copper manufacturers, aluminum producers, cement manufactures, foundries, plastics producers, PVC producers, chemical material producers, stationary diesel and turbine generators, power plants, tanning, inks and printing, paper products, paper mills, transatlantic vessels, trains, organic waste fired hospitals, refineries, rubber producers, transatlantic vessels, locomotives, medical plants, incineration plants, kitchen chimneys, odor creating industries, other industrial plants, etc. Such harmful particulates include, but are not limited to volatile organic compounds (V.O.C.s), nitrous oxide compounds (NOx), Sulphur (SOx), mercury, phosphor, and carbon oxide compounds (CO). Additionally, when coal is burned, in some countries, radiation particulates are found to be a waste product.

Legislative efforts have established emission standards to control emission wherein these standards identify how much of a certain particulate may enter the atmosphere from an exhaust air stream. Current and future compliance with such standards places a continuing demand on industry and creates an ongoing need to reduce, degrade, and eventually destroy pollutants in exhaust air stream in a cost effective manner.

Accordingly, various prior arts have disclosed such system and apparatus to reduce harmful particulates from entering the atmosphere. The following patents are herein incorporated by reference for their supportive teachings, in which:

Patent No US 20100236242 A1 discloses systems and methods for lowering levels of carbon dioxide and other atmospheric pollutants; additionally disclosing economically viable systems and processes capable of removing vast quantities of carbon dioxide and other atmospheric pollutants from gaseous waste streams and sequestering them in storage stable forms.

U.S. Pat. No. 7,163,615 B2 discloses a method of treating a substance to be degraded comprising: degrading the substance to produce degraded product; contacting the product obtained with a liquid; and entrapping a component of product not trapped by liquid in medium by contacting with medium.

U.S. Pat. No. 8,307,770 B2 discloses an apparatus and method for waste treatment by pyrolysis wherein treated waste is flushed through a grid to trap recyclable material in the pyrolysis chamber.

U.S. Pat. No. 7,135,058 B1 disclose a system for removing at least one pollutant from an air stream exhaust wherein the system comprises enclosures, a plurality of barriers, and liquefied material.

U.S. Pat. No. 8,883,105 B1 discloses methods related generally to the removal of atmospheric pollutants from gas phase as well as related apparatus, processes and uses thereof.

U.S. Pat. No. 6,086,053, issued Jul. 11, 2000, to Natschke et al. teaches of a fan guard mounted mister having plurality of spaced nozzles.

Many methods and systems are currently utilized to reduce particulates from entering the atmosphere. Such methods and systems include, but are not limited to, scrubbers, incineration techniques, exposure to ultraviolet light, mechanical filtering, electrostatic filtering, condensing heat exchangers, and etc. Even though many approaches are currently utilized to reduce harmful particulates, a certain amount of these harmful particulates still are released into the atmosphere.

### SUMMARY

In view of the foregoing disadvantages inherent in the known types of apparatus to degrade pollution percent or like in the prior art, the present invention provides an improved apparatus to degrade the percentage of pollution that enters into atmosphere that forces factory smoke to enter into treatment cylinder provided with mist systems to treat such waste gas. As such, the general purpose of the present invention, which will be described subsequently in greater detail, is to provide a new and improved perfume applicator with all the advantages of the prior art and none of the disadvantages.

Accordingly, it is an object of the present invention to provide a process and apparatus to treat waste on site on a domestic or large scale.

It is an object of the present invention to provide such an apparatus for multiple spaces like multi-occupancy residences and also individual domestic residences and commercial enterprises such as supermarkets or restaurants.

A further object of the present invention is to reduce or remove the need for the transport of waste and prevent waste ending up as landfill, allowing local authorities to meet the requirements of recycling directives.

A still further object of the present invention is to enable greater efficiency in collecting recyclable materials, improving public compliance by facilitating the recycling process.

In another embodiment, there is an apparatus to reduce the amount of pollution that exits a pollution source, comprising: a pollution carrying tube, coupled to the pollution source; a pollution cleaning tube, positioned proximate to the pollution carrying tube, having a port thereon a side; an angled elbow, connected at one end to the pollution carrying tube and coupled to the port on the side of the pollution cleaning tube; a water supply tube, coupled to the pollution cleaning tube at a first end thereof; a plurality of water misters, coupled to the pollution cleaning tube, positioned to received incoming air into the pollution cleaning tube and mix misted water into the incoming air; and a plurality of pollution extractor filters, that are designed to separate out the pollution particles that are caught in the misted water and incoming air.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is perspective and internal view of the present invention.

FIG. 2 is a perspective view of separate parts of the present invention.

### DETAILED DESCRIPTION OF THE INVENTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

In some preferred embodiments, the present invention provides improved waste treatment apparatus for carrying out waste treatment by combination of mist sprayers and water filters, the process and apparatus incorporating one or more, in any and all combinations, or all of the aspects of the invention described herein.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

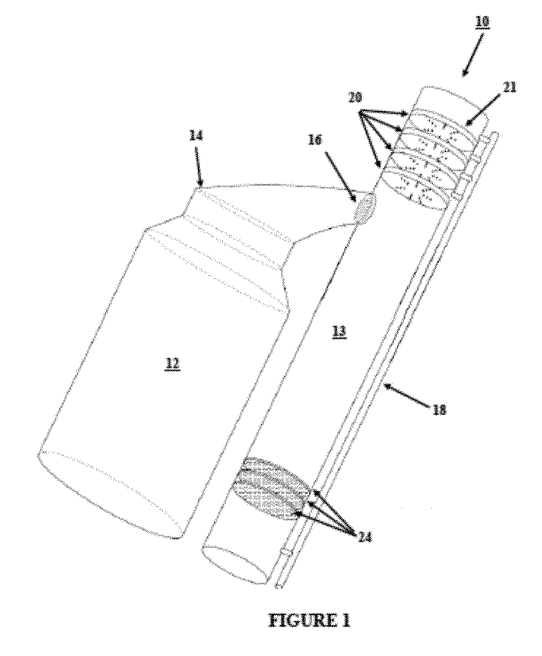

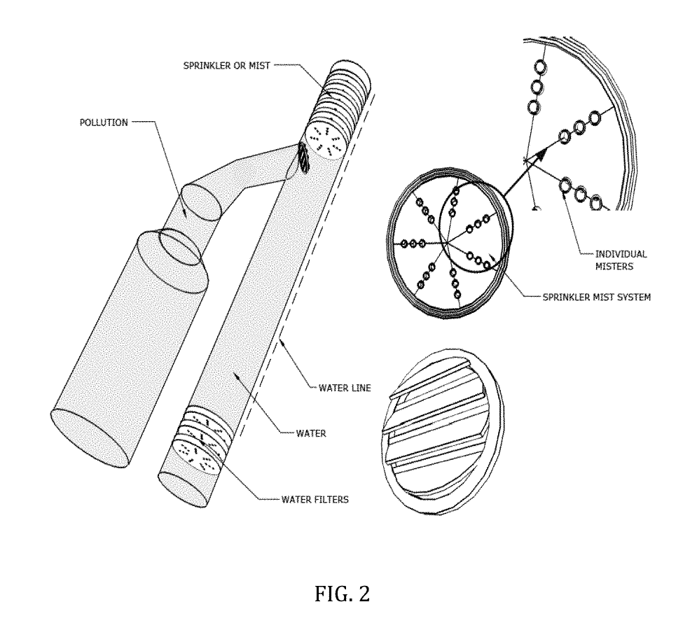

Turning now to FIGS. 1 and 2, the present invention discloses a system and apparatus to reduce the amount of pollution that exits the factory smoke stacks by forcing the pollution to pass through the pollution control apparatus 10 that degrades the pollution that flows through the system 10. The pollution control system/apparatus/device 10 constitutes a pollution carrying tube 12 and a pollution cleaning tube 13. The pollution carrying tube 12 that is hooked up to a pollution emission device, like an exhaust tube or smoke stack (not shown). Whereby, the polluted air (not shown) flows through the tube 12 and is diverted through opening/port 16 through the angled elbow 14. Water is pumped through water supply tube 18 and to individual misters 20 at a first end 21 of the pollution control device where air is pumped therethrough to mix with the water misters 20. The misted water and air are then mixed with the polluted air that enters through port 16 and this mixture is forced down pollution cleaning tube 13. Thereby, the polluted air, and mist combination is then sent through the pollution extraction filters 24 that are designed to separate out the pollution particles from the water mist that holds the pollution particles.

In a preferred embodiment, the present invention discloses an apparatus that reduces the amount of pollution that exits the factory's smoke stack by forcing the pollution to pass through the mist systems which degrades the same by weighing the pollution down by the use of misters. As disclosed, the present apparatus includes an elbow, that forces the pollution to enter the treatment cylinder and through the mist system; mist system that weighs the pollution down, degrading the amount of pollution that exits the cylinder; filters to trap contaminated water allowing only the clean water to pass through; and a water line to pump clean water back to the top to be re-uses through the mist system.

The present invention is directed towards a system and method for effectively eliminating all impurities from an exhaust air stream prior to the air being released into the atmosphere wherein no removable filters are utilized and the complete system can be automated. Such a system and method provides a low cost approach towards eliminating unwanted and harmful effects from industries that must release by-products through an exhaust system.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

1. (canceled)

2. (canceled)

3. (canceled)

4. A device to reduce an amount of pollution that comes from a pollution source, the device consisting essentially of:
a) a pollution carrying tube, coupled to the pollution source, to rout the pollution therealong;
b) a pollution cleaning tube, having a first and second end, positioned proximate to the pollution carrying tube, having a port on a side thereof positioned between the first and second end but positioned closer to the first end thereof;
c) a coupling, having a first coupling end connected to the pollution carrying tube and a second coupling end coupled to the port on the pollution cleaning tube;
d) a water supply, coupled to the pollution cleaning tube at a first end thereof;
e) a plurality of water misters, coupled to the water supply and located within the pollution cleaning tube at the first end thereof, for creating a mist of water therein; and
f) a plurality of pollution extractor filters, coupled within the pollution cleaning tube at a second end thereof;
g) wherein upon device is arranged so that a stream of air is received through the pollution cleaning tube from the first end to the second end, the stream of air will first be mixed with the mist of water from the plurality of water misters, thereby the pollution from the pollution carrying tube that is routed through the coupling and through the port is mixed with the air and the mist of water, which is thereby forced through the plurality of pollution extractor filters located at the second end of the pollution cleaning tube to extract pollution particles that are caught in the mist of water and the stream of air flowing therethrough.
